(19) United States
(12) Patent Application Publication
(10) Pub. No.: US 2002/0174610 A1
(43) Pub. Date: Nov. 28, 2002

(54) Entryway system with truss reinforced mullions

(75) Inventors: Joel S. Bennett, Greensboro, NC (US); Victor T. Massey, Greensbor, NC (US)

Correspondence Address: Steven D. Kerr, Womble Carlyle Sandridge & Rice, P.O. Box 7037, Atlanta, FL, 30357-0037, US

(73) Assignee: Endura Products, Inc.

(21) Appl. No.: 09/864,942

(22) Filed: May 24, 2001

(51) Int. Cl. E06B 1/06; E06B 1/08

(52) U.S. Cl. 52/204.1; 52/210; 52/656.4

(57) ABSTRACT

An improved sidelight and transom entryway system able to meet stringent building codes in hurricane prone coastal regions and other regions is provided. The entryway system comprises a frame formed of a sill, a pair of vertical jambs, a head jamb, a transom mull below the head jamb, and at least one mull post extending upwardly from the sill to a top end attached to the transom mull. The mull post and transom mull define a door opening, at least one sidelight panel opening, and a transom opening. The mull post and transom mull have cores formed of a multiple ply truss that extends continuously from a position adjacent the outside edges to a position adjacent the inside edges of the mullions. The trusses may be formed of Laminated Veneer Lumber (LVL) or with plies of wooden material and at least one ply of non-wooden material such as plastic, composites, fiberglass, or metal. Because of the strength imparted to the mulls by their reinforcing trusses, they are able to withstand the high pressures and resultant forces and stresses caused by high winds against a door mounted in the entryway without breaking. Further, since the screws mounting door hardware to the mull post are threaded into the multiple ply truss, the mull post will not split at the locations of hinges and other door hardware in high wind conditions as is common in traditional entryways.

### TECHNICAL FIELD

This invention relates generally to entryway systems for installation in residential and commercial buildings and more specifically to sidelight and transom entryway systems with reinforced components to withstand high wind and storm conditions.

### BACKGROUND

Many styles of modern entryway systems are available for installation in residential and commercial buildings. These include, for example, single door entryways, left, right, and dual sidelight entryways wherein sidelights or sidelight panels flank the door, and sidelight and transom entryways that include both sidelights flanking a door and a transom extending above the door and sidelights. Entryways that include sidelights or sidelights and a transom as well as patio doors with and without sidelights generally are fabricated using vertical mullions or mull posts, a horizontal continuous header, and, where a transom is included, a horizontal transom mull. The mull posts and transom mull define the door frame in which a door is installed and also frame the sidelight and transom openings. The extreme periphery of such an entryway is formed and defined by vertical jambs along the sides of the entryway and a horizontal head jamb or header across the top. A sill extends between the bottoms of the vertical jambs and the mull posts rest atop the sill intermediate its ends.

A variety of building codes in different geographic regions impose standards on entryways and, for that matter, windows and other openings, that are appropriate to the prevalent weather conditions of the region. In coastal locations, such as along the Atlantic coast of Florida, Texas, Georgia, and the Carolinas, particularly stringent standards generally are imposed because of the likelihood of the high winds and rains that can accompany hurricanes in these regions. In Florida, for instance, the Florida Uniform Building Code requires that entryways and windows of residential buildings along the coast be certified to withstand extremely high pressures that are caused by high winds.

Traditionally, many mull posts and transom mulls of entryways have been fabricated from a number of relatively short pieces of wood such as Eastern white pine that are finger jointed end to end and milled to form the mull profile. While such construction is acceptable in many regions, it generally does not result in mull posts and transom mulls that are able to meet more stringent building codes in coastal and other regions of extreme weather conditions. For instance, when an entryway with traditional finger jointed mull posts and transom mull is exposed to pressures that entryways in coastal areas must withstand, the forces transferred through the door to the mulls will cause the mulls and thus the entryway to fail. Many times, the mulls break apart at the locations of the finger joints. Even where the finger joints hold, the wood of the mulls often splits apart along its grain at the locations of door hardware such as the strike plate, deadbolt strike, and hinges, all locations where the forces imparted to the door by pressure are concentrated and transferred to the mulls. Further, the pressure can cause the mulls to deflect or bend, compromising the integrity of hardware fasteners. The stop rabbet milled into the mulls also can be a location where splitting occurs. For these and other reasons, traditional finger jointed mull posts and transom mulls generally are not acceptable for use in regions with stringent design pressure requirements. Even where a solid wood mull design is used to eliminate failure at finger joint locations, the problems caused by splitting of the wood along its grain at the locations where door hardware is attached to mull posts persists.

In addition to high design pressure requirements in hurricane prone regions, building codes in such regions further require that an entryway withstand a direct impact by airborne debris such as tree limbs. In a hurricane, such debris can be hurled by the wind at high speeds and has been known to impale itself through doors or otherwise to impact, break, and split the mull posts or transom mulls of entryways causing the entryway to fail. A standard test of an entryway to insure that it can withstand such an event involves the firing of a 2×4 timber at the entryway with an air cannon. The 2×4 typically is fired numerous times and aimed at different areas of the entryway such as the door, the mull posts, the transom mull, and the jambs, to insure that the entryway meets the impact resistance required by building codes. If the mull posts and transom mull are unable to withstand the impact of the 2×4 test missile, then the entryway can not be certified as meeting coastal building codes, even if the door itself and the jambs do withstand the test impacts. Traditional finger jointed or solid wood mull posts and transom mulls generally are unable to pass the impact tests.

In order to provide sidelight, patio, and transom entryways that meet stringent coastal building codes, manufactures of such entryways have resorted to a variety of structural designs. For instance, entryways with extruded aluminum mull posts and transom mulls can satisfy the building codes and often are used in commercial buildings. However, such metal mullions generally are not acceptable in appearance for use in private residences and also can be cost prohibitive for residential use. At least one manufacturer has introduced a mullion design wherein the outside post portion of the mullion is made of a laminated plywood material with the inside portion being made of wood that is finger jointed and glued along its length to the plywood post to form a composite mull. While such a design can eliminate the failure at the horizontal finger joints of a traditional mull, it nevertheless fails to address other modes of failure such as, for instance, the splitting apart of the inside wood portion of the mull where strike plates and hinges are attached. In some cases, builders fabricate mulls by sandwiching a strip of plywood between two back to back wood jambs, however, this is time consuming, unsightly, and does not result in a structure of consistent and reliable strength.

Thus, a need exists for an entryway system incorporating mull posts and transom mull designs that successfully meets and exceeds design requirements imposed by stringent building codes such as those in coastal regions. Such an entryway system should eliminate all failure modes including failure of finger joints and splitting of wood at strike plate and hinge attachment points. Further, the mullions of the entryway should emulate the appearance of a traditional wooden mullion so that it is acceptable for use in private residences and should be cost effective for such use. Preferably, the mullions should be stronger and more resistant to pressure and impact than the door itself such that the entire entryway may be certified by a pre-hanger based solely upon the integrity of a door installed in the entryway. It is to the provision of such an entryway system that the present invention is primarily directed.

### SUMMARY OF THE INVENTION

Briefly described, the present invention, in a preferred embodiment thereof, comprises a sidelight or sidelight and transom entryway system incorporating a unique mull post and transom mull design capable of meeting the most stringent building codes. Both the mull posts and transom mull of the entryway are formed with a core made of a multi-ply laminated truss that extends along the entire length of the mullion and that extends continuously from a position adjacent the outside edge of the mullion to a position adjacent its inside edge thereof. In one embodiment, the truss is made of laminated veneer lumber (LVL), In other embodiments, some of the plies of the truss are formed of wood and others are formed of other materials such as, for example, plastic, carbon composites, fiberglass, metal, or another appropriate material to enhance the strength of the truss. The truss preferably is covered or clad by a wooden exterior such as traditional Eastern white pine. The exterior wooden cladding is milled in the traditional way to form the stops, weather strip rabbets, and decorative molding portions of the mull. In this way, the mullions have an exterior appearance that is virtually indistinguishable from that of traditional solid wood or finger jointed mullions.

In use, an entryway is fabricated according to the invention by attaching the vertical mull posts at their bottoms to a sill at locations spaced from the jambs of the entryway. The mull posts are attached at their top ends with appropriate extra long screws to a horizontal transom mull that also incorporates the truss according to the invention. The ends of the transom mull are attached with appropriate fasteners such as screws to the vertical jambs of the entryway. Thus, the vertical mull posts and the transom mull form a door opening for the door and also define and frame sidelight openings that flank the door and a transom opening above the door. When a door is hung in the entryway, the screws that attach the hinges to one of the mull posts are screwed through the wood cladding of the mull and into the multi-ply truss that forms the core of the mull. Likewise, the screws that attach the strike plate and deadbolt strike to the other mull are screwed through the wooden exterior cladding and into the truss of the mull.

When the entryway of this invention is exposed to high wind pressures, extreme forces are transferred from the door, sidelights, and transom to the mull posts and to the transom mull. Since there are no finger joints along the lengths of these components, however, and because of the multi-ply truss at their cores, failure of the mullions at weak points along their lengths is completely eliminated. Further, because the truss spans substantially the entire width of the mullions allowing attachment screws at hinges and strike plates to be screwed into the truss, splitting and breakage of the mullions at these locations where traditional failure occurs also is eliminated. The result is a sidelight and transom entryway system in which the mull posts and transom mull assembly is at least as strong as and likely stronger than a door mounted in the entryway. Thus, the door itself will fail under conditions of high wind pressure before the truss reinforced mulls.

In addition, it has been demonstrated that an entryway fabricated with truss reinforced mullions according to the invention is able to withstand repeated direct impacts by a 2×4 test missile fired at the mull posts and transom mull. Thus, these components of the entryway fully meet and likely exceed the stringent requirements of building codes in hurricane prone and other regions of the country. For the prehanger, who manufactures door systems to be installed in entryways, the certification of an entryway as meeting a particular building code is determined jointly by the certification of the door itself and the mullions and frame system along with other components of the entryway. Accordingly, certification of an entryway to meet a particular building code is simply a matter of submitting the proper door and the test certificate of the entryway mull frame system and the extensive testing required in the past for such certification may be avoided.

Thus, an improved sidelight and transom entryway is now provided that eliminates mullion failure, that incorporates mull posts and a transom mull that appear virtually identical to those of traditional entryways and thus acceptable for use in private residences, and that is cost effective. The same truss reinforced mull design can be used for an entire line of entryways with the code certification of a particular entryway being determined solely by a combination of the door installed in the entryway frame system. These and other features, objects, and advantages of the invention will become more apparent upon review of the detailed description set forth below when taken in conjunction with the accompanying drawing figures, which are briefly described as follows.

### BRIEF DESCRIPTION OF THE DRAWINGS

FIG. 1 is a cross sectional view of a truss reinforced mullion for use in an entryway that embodies principles of the invention.

FIG. 2 is a cross sectional view of a truss reinforced jamb for use in an entryway that embodies principles of the invention.

FIG. 3 is a plan view of a sidelight and transom entryway system that embodies principles of the present invention in a preferred form.

### DETAILED DESCRIPTION OF THE PREFERRED EMBODIMENTS

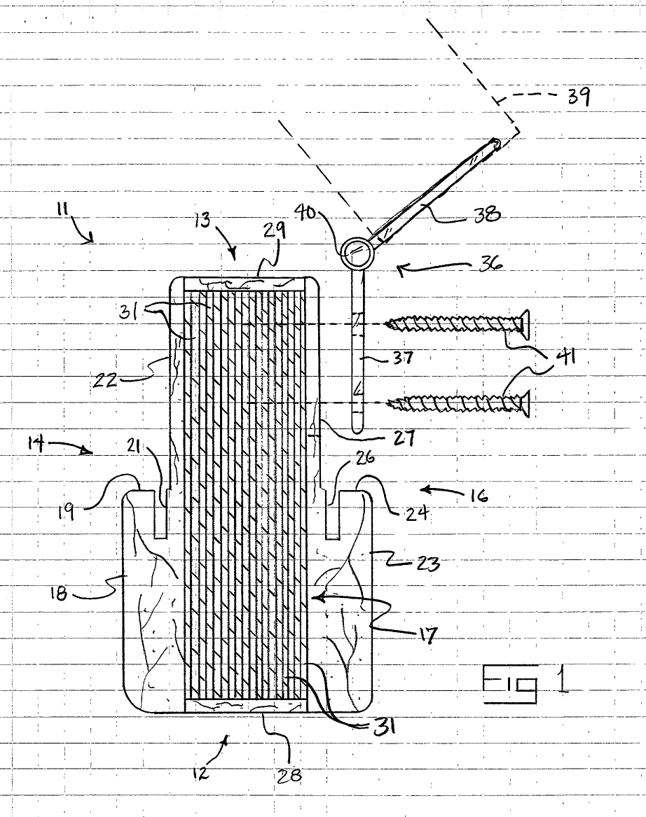

Referring now in more detail to the drawings, in which like reference numerals, where appropriate, refer to like parts throughout the several views, FIG. 1 illustrates in cross section a mullion that embodies principles of the invention in a preferred form. It will be understood that the construction of the mullion of FIG. 1 could be either that of a vertical mull post of an entryway or a horizontal transom mull. The mullion 11 has an outside edge 12, which normally faces outwardly, an inside edge 13, which normally faces the interior of a structure, a first side 14, and a second side 16. At the core of the mullion is a multiple ply truss 17, which extends from a position adjacent the outside edge 12 of the mullion continuously to a position adjacent the inside edge 13 thereof.

The first side 14 of the mullion is formed by a wooden side facing 18, which is glued to and clads the side of the truss 17. The wooden side facing 18 is milled in the traditional manner to form a longitudinal stop 19 that extends along the length of the mullion and against which a door or sidelight panel may rest. A weather strip or stop rabbet 21 is milled in the stop 19 for receiving and holding a length of weather strip for engaging and sealing against a door or sidelight panel. A face 22 extends inwardly from the stop to the inside edge 13 of the mullion. It will be appreciated that the wooden side facing 14 is profiled to form a mullion side of traditional shape like that of a common finger jointed or solid wood mullion. Similarly, a wooden side facing 23 covers and is glued to the other side of the truss 17 and is milled to define a longitudinally extending stop 24, a stop rabbet 26 for receiving a length of weather strip, and a face 17 extending from the stop 24 to the inside edge 13 of the mullion. Thus, the mullion of FIG. 1 is symmetrically shaped; however, this certainly is not a requirement of the invention.

A wooden outside facing strip 28 is glued to and covers the outside edge of the truss 17 and a wooden inside facing strip 29 is glued to the inside edge of the truss 17. With this configuration, it will be seen that the truss 17 is completely covered and encased or clad by the wooden facings 18, 23, 28, and 29. In this way, the mullion 11 has an outer appearance that is virtually indistinguishable from that of a standard solid wood mullion and its exterior surface is paintable, stainable, or otherwise may be finished in any traditional manner just as a prior art wood mullion.

The truss 17 itself is fabricated from a plurality of individual plies 31 of material glued or otherwise adhered together to form the multiple ply structure of the truss. The material and structure of the plies 31 may be varied depending upon the ultimate use and desired strength of the mullion. For instance, the truss 17 may be a traditional engineered lumber product commonly known and Laminated Veneer Lumber (LVL) wherein all of the plies 31 are made of wood veneers. The types of wood used to form the veneers of the plies may vary and the plies may be oriented such that their grains extend in different directions to enhance the strength of the truss. Various types of LVL commonly are available from vendors of engineered lumber and are well known by those of skill in the art.

As an alternative to LVL, the truss 17 may be formed from plies 31 made of a mixture of wood and other materials to enhance the strength of the mullion. For example, some of the plies 31 may be wood veneers while other plies interspersed with the wood plies may be another material such as, for instance, plastic, carbon composites, other composites, fiberglass, or even metal such as aluminum. The use of such non-wooden plies combined with wooden plies may form a truss of exceptional strength and resistance to failure under even the most severe load conditions.

FIG. 1 also illustrates the attachment of a hinged door 39 to the mullion 13 in order to demonstrate and discuss some of the superior performance characteristics of the mullion configuration of this invention. The hinges 36 (only one of which is visible in FIG. 1) that support the door 39 each has a frame wing 37 and a door wing 38 pivotally attached by a hinge pin 40. The door wing 38 traditionally is nestled within a hinge rabbet formed along the edge of the door and is attached to the door with wood screws that extend into the material of the door. Likewise, the frame wing 37 of the hinge is nestled within a hinge rabbet formed in the face 27 of the mullion 11 and attached with wood screws 41.

As discussed above, in traditional solid wood or finger jointed wood mullions, the attachment points of the hinges to the mullion tend to be regions of failure under extreme wind induced pressures on the door. This is because the forces generated by such pressures are concentrated and transferred to the mullion at the locations of the hinges (as well as the strike plates and deadbolt plates on the other side of the door). These concentrated forces are in a direction perpendicular to the mullion and thus perpendicular to wood grain thereof and, in finger jointed mullions, parallel to the directions of the finger joints. As a result, traditional mullions tend to split along their grain at the locations of the hinges and other door hardware and the inward forces along the length of the mullion tend to cause failure at the locations of finger joints.

However, with the mullion of the present invention as illustrated in FIG. 1, the screws 41 that attach the hinges (and other door hardware) to the mullion extend deeply into the multiple ply reinforcing truss of the mullion rather than into the grain of solid wood. Since the grains of the plies 31 are oriented in various directions, the tendency for inward force at the locations of the hinges to split the mullion along its length is eliminated. Furthermore, threading screws into a plywood material such as LVL, usually containing at least some plies of hardwood, forms a far stronger attachment in general as compared to treading screws into the solid pine of traditional mullions. Accordingly, the screws do not tend to be pulled out of the mullion under the stress of extreme pressure induced forces. This is even more true where the truss may include plies of non-wooden materials such as plastic or metal.

The overall result is that an entryway fabricated with mullions according to FIG. 1 is extraordinarily strong and resistant to failure due to inwardly directed forces caused by the pressure of high winds on a closed door. In fact, it has been found that in an entryway according to this invention, the strength of the mull posts and transom mull far exceeds that required to meet the design pressure requirements of even the most stringent building codes, both in terms of wind pressure failure and missile impact resistance. Thus, the certification of the entryway for a particular building code is determined by the certification of the door itself and not the mullions. This is an advantage to pre-hangers using as a standard the entryway system of the present invention because only the doors to be installed in the entryway and not the entire entryway need be tested to certify the entryway for a particular building code.

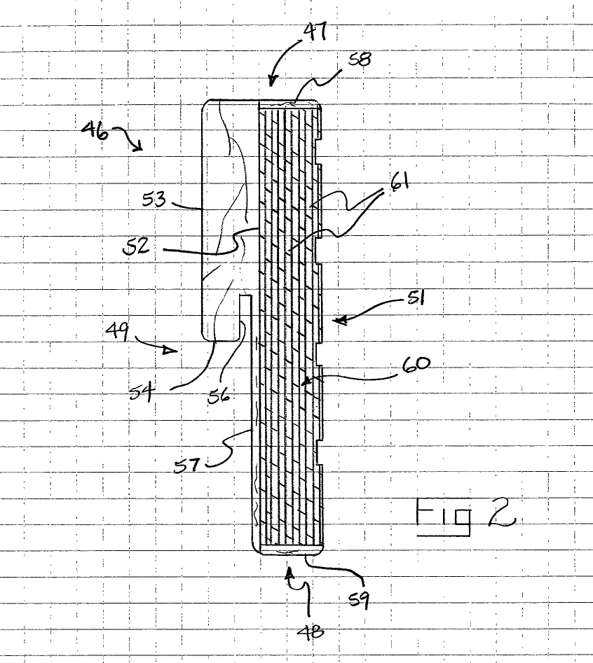

FIG. 2 illustrates a variation of the mullion of FIG. 1 in the form of a truss reinforced jamb for use as the vertical jambs and/or head jamb of an entryway. The jamb 46 has an outside edge 47, and inside edge 48, an exposed face 49 and a back face 51. As with the mullion of FIG. 1, the core of the jamb 46 is formed of a truss 60 fabricated of multiple plies 61 of materials such as wood, plastic, composites, and/or metal. The exposed face 49 of the jamb is formed by a wood facing 53 milled to define a traditional stop 54, a stop rabbet 56 for receiving weather stripping, and a face 57 that extends to the inside edge 48 of the jamb. The outside edge of the truss 60 is covered by a wood facing strip 58 and the inside edge of the truss is covered by a wood facing strip 59. With such a jamb construction, it will be seen that, just as with the mullion of FIG. 1, the jamb 46 has the outward appearance of a traditional solid wood or finger jointed jamb and may be finished and machined in the same ways. However, the multi-ply reinforcing truss 60 that forms the core of the jamb provides all the strength and failure resistance features discussed above relative to the mullion of FIG. 1.

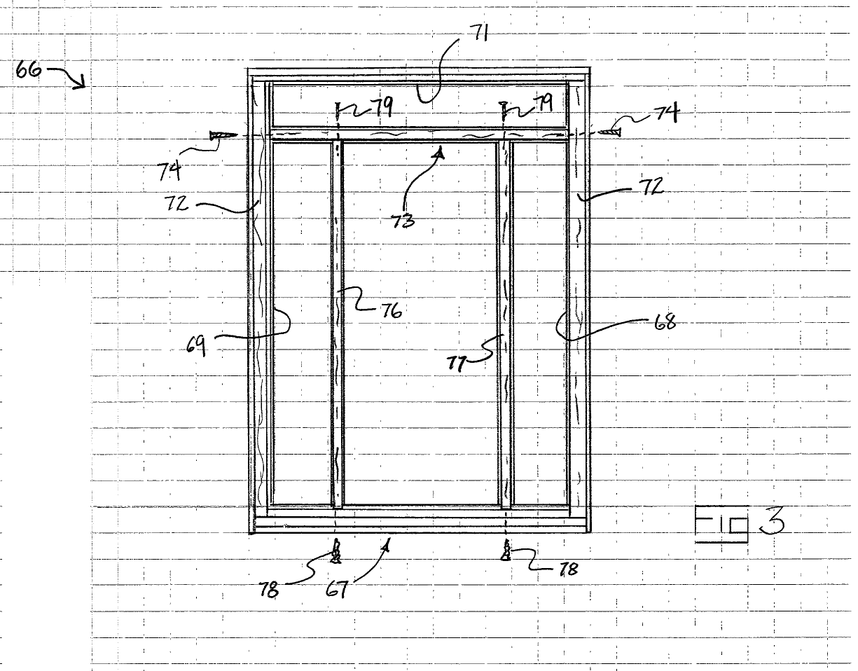

FIG. 3 illustrates an entryway (sans door) fabricated according to principles of the present invention and as seen from an inside perspective. The entryway 66 is illustrated as a sidelight and transom entryway wherein sidelight panels flank the door opening and a transom opening extends across the top of the entryway. More specifically, the entryway comprises a pair of vertically extending jambs 68 and 69 that are attached at their bottom ends to and extend upwardly from a sill assembly 67. A head jamb or header 71 joins the top ends of the vertical jambs 68 and 69 and extends horizontally across the top of the entryway. Decorative casing 72 is illustrated attached to the inside edges of the vertical jambs as would be common after installation of the entryway in a building.

The vertical jambs 68 and 69 as well as the head jamb 71 may be formed with truss reinforced cores as illustrated in FIG. 2; however, they also may be of traditional solid or finger jointed wood construction if desired. This is because the strength of the jambs is not as critical as that of the mullions of the entryway since the jambs are secured directly to the heavy construction framing that frames the opening into which the entryway system is installed. Accordingly, forces imparted to the jambs are transferred directly to the framing timbers and splitting and failure of the jambs generally is less a problem that failure of the otherwise unsupported mullion members. Nevertheless, truss reinforced jambs according to the invention are preferred, particularly where a door may be mounted to or close against a jamb, to prevent splitting along the wood grain at the locations of door hardware under extreme wind conditions.

A pair of spaced apart vertical mull posts 76 and 77, which are fabricated with reinforcing trusses according to the invention, are attached at their bottom ends with screws 78 or other appropriate fasteners to the sill assembly 67 and extend upwardly therefrom. A horizontal transom mull 73 is attached at its ends with screws 72, to and extends between the vertical jambs 68 and 69. The top ends of the vertical mull posts 76 and 77 meet and are attached with screws 79 to the transom mull 73. With regard to the mating together of the attached components, it will be understood that the ends of the mull posts and the ends of the transom mull are milled with appropriate haunches and the like to form a substantially seamless joint in the traditional way. Screws 74, 78, and 79 are used in place of staples found in many common doors to provide exceptional strength where the mulls and jambs meet. In this regard, for meeting stringent building code requirements, these screws may be extra long and/or multiple screws may be used at each joint as required to provide the desired strength. In addition, weather proof adhesive, dowels, or other means also may be used at the joints to enhance their strength. As with the attaching screws of door hardware, the screws that join the mulls and jambs extend into the multi-ply trusses of the components to form exceptionally strong and highly reliable joints.

With the entryway system configured as described, the vertical mull posts 76 and 77, the horizontal transom mull 73, and the jambs and sill assembly are seen to frame a central opening for receiving a hinged door, a pair of sidelight openings flanking the central opening for receiving sidelight panels, and a transom opening over the door and sidelight openings for receiving a transom panel. When completely installed, a door is hingedly mounted to one of the mull posts and the strike plate and deadbolt strikes to receive the bolts of the door are mounted to the other mull post. For all such door hardware, the mounting screws extend into the truss at the core of the mull posts to provide the advantages discussed above. Sidelight panels, which may be glass panels or solid panels, are mounted in the sidelight openings flanking the door and a transom panel, which, again, may be a solid panel or a glass panel, is mounted in the transom opening in the usual way.

With the entryway of FIG. 3 installed in a dwelling that is subjected to the high winds of a hurricane or other storm, the door and panels can be subjected to extreme pressures and consequently extreme inwardly directed forces. These forces are transferred from the door and panels to the truss reinforced mullions of the entryway, which, due to their unique construction according to the invention, resist the failure modes common for traditional mull posts and transom mulls. Ultimately, much of the force born by the mullions are transferred to the vertical jambs and the sill assembly and, in turn, to the framing timbers of the building. Due to the unique construction of the mullions and perhaps also the jambs of the entryway 66, the entryway has been observed to withstand these forces as required by stringent building codes without failure. Further, flying projectile tests wherein 2×4 timbers are fired directly at the mull posts and transom mull of an entryway fabricated according to the invention have demonstrated that the entryway is extremely resistance to breakage and failure as a result of such impacts and exceeds design requirements.

The invention has been described herein in terms of preferred embodiments and methodologies. It will be understood by those of skill in the art, however, that various modifications of the illustrated and discussed embodiments may well be made within the scope of the invention. For instance, the inventive truss reinforcement may be used in window frames as well as entryways and may be applied to entryways with a transom and only one sidelight. Application to entryways of other configurations also is envisioned. The material from which the facings that covers the truss cores discussed herein is wood. However, other materials such as, for example, wood composites and extruded plastic facings also may be used. Further, the exterior configurations of the components illustrated herein are common; however, they are not limiting and any exterior profile of a mullion or jamb required for a particular installation may be selected. These and other additions, deletions, and modifications to the illustrated embodiments may well be made by skilled artisans without departing from the spirit and scope of the invention as set forth in the claims.

What is claimed is:

1. An entryway system comprising:
an elongated sill having ends;
a pair of spaced jambs extending upwardly from respective ends of said sill to upper ends;
a head jamb extending horizontally between said upper ends of said jambs;
a transom mull extending between said jambs a predetermined distance below said head jamb to define a transom opening, said transom mull having an outside edge and an inside edge; and
at least one mull post extending upwardly from said sill to a top end attached to said transom mull to define a door opening and a sidelight opening, said mull post having an outside edge and an inside edge;
said mull post having a core formed of a multiple ply truss extending continuously from a position adjacent said outside edge of said mull post to a position adjacent said inside edge of said mull post.

2. An entryway system as claimed in claim 1 and wherein said truss is formed of LVL.

3. An entryway system as claimed in claim 1 and wherein said truss has plies of wood veneer and plies of a non-wooden material.

4. An entryway system as claimed in claim 3 and wherein said non-wooden material includes plastic.

5. An entryway system as claimed in claim 3 and wherein said non wooden material includes composites.

6. An entryway system as claimed in claim 3 and wherein said non-wooden material includes fiberglass.

7. An entryway system as claimed in claim 3 and wherein said non-wooden material includes metal.

8. An entryway system as claimed in claim 1 and wherein said mull post has side facings formed of wood, said side facings being milled to form stops extending along the length of the mull post.

9. An entryway system as claimed in claim 8 and wherein at least one of said side facings is further milled to form a stop rabbet for receiving a length of weather stripping.

10. An entryway system as claimed in claim 8 and further comprising an outside facing strip made of wood extending along said outside edge of said mull post and an inside facing strip made of wood extending along said inside edge of said mull post, said side facings and said outside and inside facing strips encasing said truss within said mull post.

11. An entryway system as claimed in claim 1 and further comprising a door mounted in said door opening, a sidelight panel mounted in said sidelight opening, and a transom panel mounted in said transom opening.

12. An entryway system as claimed in claim 1 and wherein said transom mull has a core formed of a multiple ply truss extending continuously from a position adjacent said outside edge of said transom mull to a position adjacent said inside edge of said transom mull.

13. An entryway system as claimed in claim 12 and wherein said mull post is joined to said transom mull with at least one screw extending through said transom mull into said truss of said mull post.

14. An entryway system as claimed in claim 1 and comprising two spaced mull posts extending upwardly from said sill to top ends attached to said transom mull, each of said mull posts having an outside edge, an inside edge, and a core formed of a multiple ply truss extending continuously from a position adjacent said outside edge to a position adjacent said inside edge of said mull post, said mull posts and said transom post defining a central door opening, a pair of sidelight panel openings flanking said door opening, and a transom opening above said door and said sidelight panel openings.

15. An entryway system as claimed in claim 14 and wherein said transom mull has a core formed of a multiple ply truss extending continuously from a position adjacent said outside edge of said transom mull to a position adjacent said inside edge of said transom mull.

16. An entryway system as claimed in claim 15 and wherein said trusses of said mull posts and said transom mull are formed of LVL.

17. An entryway system as claimed in claim 15 and wherein some of said plies of said trusses are formed of wood and at least one of said plies is formed of a non-wooden material.

18. An entryway system as claimed in claim 17 and wherein said non-wooden material includes plastic.

19. An entryway system as claimed in claim 17 and wherein said non-wooden material includes a composite.

20. An entryway system as claimed in claim 17 and wherein said non-wooden material includes fiberglass.

21. An entryway system as claimed in claim 17 and wherein said non-wooden material includes metal.

22. In a sidelight and transom entryway having at least one vertical mull post with an outside edge and an inside edge and a horizontal transom mull with an outside edge and an inside edge, the improvement comprising a core within said mull post and a core within said transom mull, said cores being formed by multiple ply trusses.

23. The improvement of claim 22 and wherein said trusses are formed of LVL.

24. The improvement of claim 22 and wherein said trusses are formed with plies of wood and at least one ply of a non-wooden material.

25. The improvement of claim 24 and wherein said non-wooden material is selected from a group comprising plastic, composites, fiberglass, and metal.
